(19) United States
(12) Patent Application Publication
(10) Pub. No.: US 2024/0349921 A1
(43) Pub. Date: Oct. 24, 2024

(54) INFANT FOOD CHEWING DEVICE

(71) Applicant: THINK GREEN LIMITED, Auckland (NZ)

(72) Inventor: Shuting Zhang, Jingshan (CN)

(21) Appl. No.: 18/486,690

(22) Filed: Oct. 13, 2023

(30) Foreign Application Priority Data
Apr. 20, 2023 (CN) 202320908828.1

(51) Int. Cl. A47G 21/00

(52) U.S. Cl. CPC A47G 21/00; A47G 2200/00

(57) ABSTRACT

An infant food chewing device includes a net bag, a cover, and a fixing hoop. The net bag includes a bag body having a receiving cavity. A cavity wall of the receiving cavity is provided with several through holes. A first fixing ring extends from one side of an open end of the bag body. The cover includes a cover body having a mounting side surface. An enclosing wall and a blocking block are disposed on the mounting side surface. The blocking block is located in an annular area of the enclosing wall. The blocking block has a blocking side face abutting an end face of the open end and blocking the open end. The fixing hoop is sleeved on the outer periphery of the blocking block and the first fixing ring. The enclosing wall at least partially shields the outer side surface of the fixing hoop.

### CROSS-REFERENCE TO RELATED APPLICATION(S)

This application claims priority to Chinese Patent Application No. 202320908828.1 filed Apr. 20, 2023, the disclosure of which is incorporated herein by reference in its entirety.

### TECHNICAL FIELD

The present application relates to the field of infant products and, in particular, an infant food chewing device.

### BACKGROUND

During the process of feeding infants, liquid food can be fed using baby utensils such as bottles. However, as infants grow, the infants need to supplement various nutrients and exercise their eating skills. When selecting solid foods such as fruits, vegetables, or meats, infants with weak self-control can easily swallow these food without chewing, which can lead to choking, posing a significant risk to their health. Therefore, chewing devices to aid infant feeding are widely used.

Existing chewing devices generally include an upper body part, a lower body part, and a silica gel net. The upper body part is typically made of plastic, and the lower body part is equipped with a fastener on one or both sides. After food is placed into the silica gel net, the silica gel net passes through a mounting position of the lower body part, and then the upper and lower body parts are assembled and fixed together with the fastener.

The related art has the following defects: During use, if the infant inserts the chewing device too deeply into their mouth, leading to unreasonable use (biting beyond the acceptable range), the upper body part can easily separate from the lower body part and the silica gel net under the force of biting and pulling. At this point, the lower body part loses its fixing function, and the silica gel net can easily separate from the lower body part. If the silica gel net is small, there is a substantial risk that the infant may accidentally swallow the silica gel net.

### SUMMARY

An embodiment of the present application provides an infant food chewing device. The infant food chewing device is stable in structure and a silica gel net is not prone to falling off.

The present application uses the solutions below.

An infant food chewing device is provided. The device includes a net bag, a cover, and a fixing hoop. The net bag includes a bag body. The bag body has a receiving cavity. A cavity wall of the receiving cavity is provided with several through holes for food to pass through. A first fixing ring extends from one side of an open end of the bag body facing away from the center of the open end. The cover includes a cover body having a mounting side surface. An enclosing wall and a blocking block are disposed on the mounting side surface. The blocking block is located in an annular area of the enclosing wall. The blocking block and the enclosing wall are spaced apart. The blocking block has a blocking side face abutting an end face of the open end and blocking the open end. The fixing hoop is sleeved on the outer periphery of the blocking block and the first fixing ring. The fixing hoop is detachably connected to the blocking block and the first fixing ring. The enclosing wall at least partially shields the outer side surface of the fixing hoop.

In an optional solution of the infant food chewing device, the outer side surface of the fixing hoop includes an outer peripheral side face and a first transition arc face connected to the outer peripheral side face. The first transition arc face is a convex arc face. The outer peripheral side face and the first transition arc face are disposed in an axial direction of the fixing hoop. The first transition arc face is disposed on one side of the outer peripheral side face close to the net bag. The enclosing wall shields at least the outer peripheral side face.

In an optional solution of the infant food chewing device, the enclosing wall shields a portion of the first transition arc face.

In an optional solution of the infant food chewing device, the blocking side face is provided with a fitting portion. The fitting portion is inserted in the open end. An end face of the enclosing wall protrudes from the blocking side face.

In an optional solution of the infant food chewing device, the thickness of the enclosing wall gradually reduces in a direction from the cover to the net bag.

In an optional solution of the infant food chewing device, one side surface of the enclosing wall facing away from the fixing hoop is an inclined surface.

In an optional solution of the infant food chewing device, an included angle between the inclined surface and one side surface of the enclosing wall facing the blocking block is θ. 15°≤θ≤25°.

In an optional solution of the infant food chewing device, θ=20°.

In an optional solution of the infant food chewing device, an end face of the enclosing wall is a second transition arc face. The second transition arc face is a convex arc face.

In an optional solution of the infant food chewing device, the device includes a dust cover. A first buckle member is disposed on one side surface of the enclosing wall facing away from the blocking block. A second buckle member is disposed on the inner wall of the dust cover. The first buckle member and the second buckle member are buckled. The net bag and the fixing hoop are located inside the dust cover.

The present application has the beneficial effects below. The fixing hoop connects and fixes the net bag and the cover, improving the connection strength between the cover and the net bag, and reducing the probability of the net bag detaching during use. The enclosing wall is disposed on the cover and shields a portion of the fixing hoop. If the infant excessively pushes the net bag into the mouth and the biting range extends to an area near the fixing hoop, the infant's direct biting area on the fixing hoop becomes relatively small under the shielding of the enclosing wall. More biting force is applied directly to the enclosing wall of the cover. That is, the effective biting area on the fixing hoop is minimized to prevent the infant from pulling off the fixing hoop from the food chewing device during use, ensuring the connection stability between the net bag and the cover, and avoiding a scenario where the infant might swallow the net bag mistakenly due to the net bag falling off.

### BRIEF DESCRIPTION OF DRAWINGS

The present application is further described below in detail in conjunction with drawings and embodiments.

FIG. 1 is a schematic view of an infant food chewing device according to an embodiment of the present application;

FIG. 2 is a sectional view of an infant food chewing device according to an embodiment of the present application;

FIG. 3 is an exploded view of an infant food chewing device according to an embodiment of the present application;

FIG. 4 is a schematic view of an infant food chewing device (dust cover not shown) according to an embodiment of the present application;

FIG. 5 is a sectional view of an infant food chewing device (dust cover not shown) according to an embodiment of the present application;

FIG. 6 is a sectional view of a cover according to an embodiment of the present application;

FIG. 7 is a sectional view of a fixing hoop according to an embodiment of the present application;

FIG. 8 is a sectional view of a net bag according to an embodiment of the present application; and

FIG. 9 is a sectional view of a dust cover according to an embodiment of the present application.

### REFERENCE LIST

1 cover
11 blocking block
111 fitting portion
112 second clamping groove
113 blocking side face
12 enclosing wall
121 second transition arc face
122 inclined surface
123 first buckle member
13 handle
131 first protrusion
1311 bristle
132 second protrusion
1321 massage protrusion
2 fixing hoop
21 mounting hole
22 second fixing ring
221 first clamping block
23 outer peripheral side face
24 first transition arc face
25 second clamping block
3 net bag
31 bag body
311 receiving cavity
312 through hole
32 first fixing ring
321 first clamping groove
4 dust cover
41 second buckle member

### DETAILED DESCRIPTION

To make solved problems, adopted solutions and achieved effects of the present application clearer, the solutions in the embodiments of the present application are further described in detail in conjunction with the drawings. Apparently, the embodiments described below are part, not all, of the embodiments of the present application. Based on the embodiments described herein, all other embodiments obtained by those of ordinary skill in the art without creative work are within the scope of the present application.

In the description of the present application, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internally connected between two elements or interaction relations between two elements. For those of ordinary skill in the art, specific meanings of the preceding terms in the present application may be understood based on specific situations.

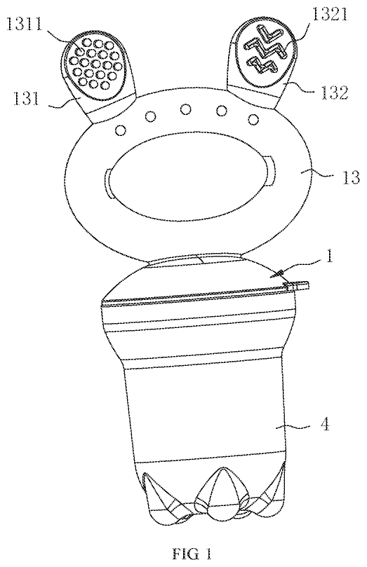

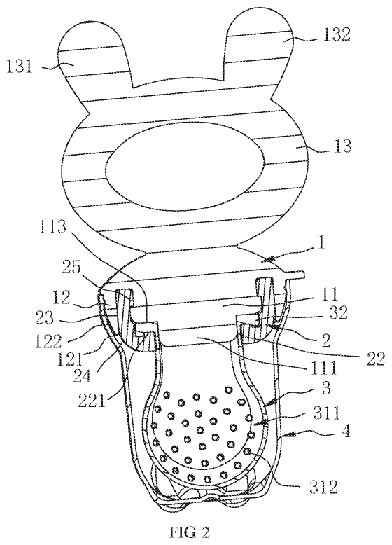

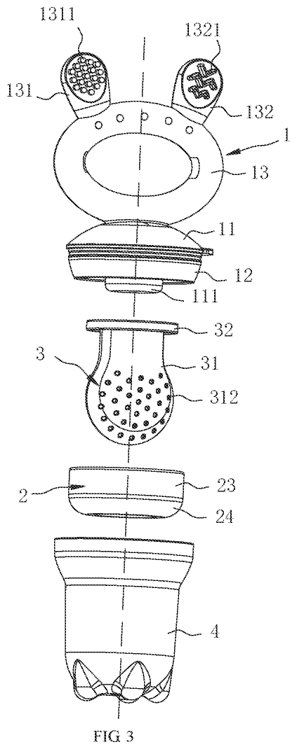

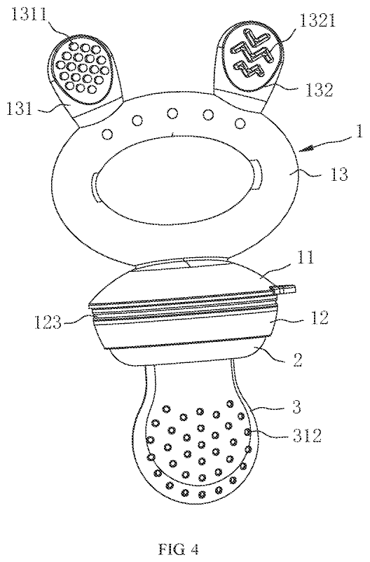

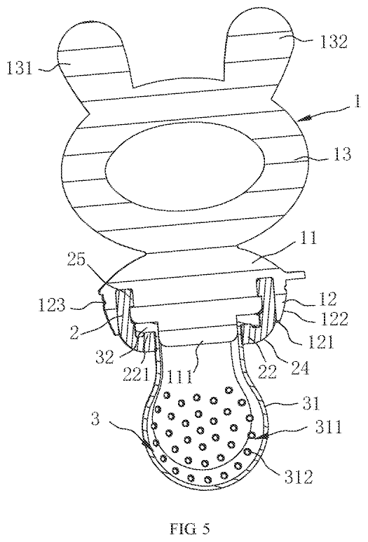

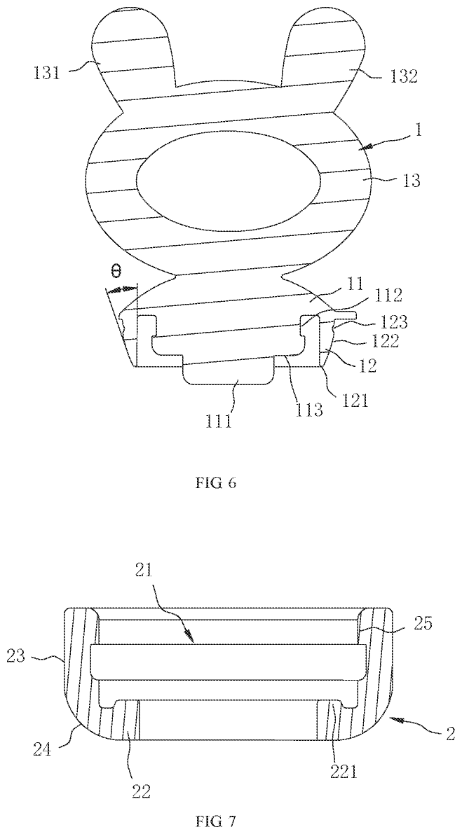

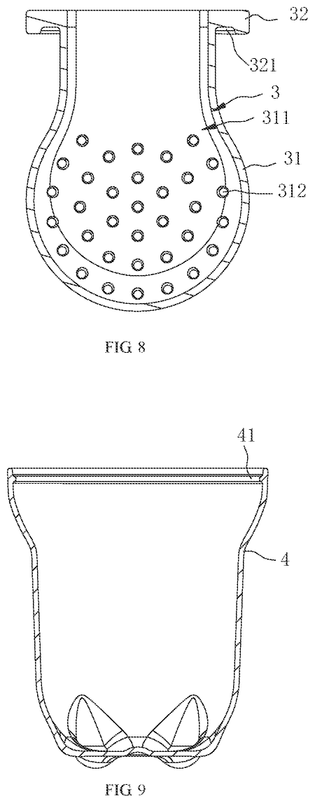

As shown in FIGS. 1 to 8, the present application provides an infant food chewing device including a net bag 3, a cover 1, and a fixing hoop 2. The net bag 3 includes a bag body 31 having a receiving cavity 311. A cavity wall of the receiving cavity 311 is provided with several through holes 312 for food to pass through. A first fixing ring 32 extends from one side of an open end of the bag body 31 facing away from the center of an open end. The cover 1 includes a cover body having a mounting side surface. An enclosing wall 12 and a blocking block 11 are disposed on the mounting side surface. The blocking block 11 is disposed in an annular area of the enclosing wall 12. The blocking block 11 and the enclosing wall 12 are spaced apart. The blocking block 11 has a blocking side face 113 abutting an end face of the open end and blocking the open end. The fixing hoop 2 is sleeved on the outer periphery of the blocking block 11 and the first fixing ring 32. The fixing hoop 2 is detachably connected to both the blocking block 11 and the first fixing ring 32. The enclosing wall 12 at least partially shields the outer side surface of the fixing hoop 2. The fixing hoop 2 connects and fixes the net bag 3 and the cover 1, improving the connection strength between the cover 1 and the net bag 3, and reducing the probability that the net bag 3 falls off during use. The enclosing wall 12 is disposed on the cover 1. The enclosing wall 12 shields a portion of the fixing hoop 2. If the infant excessively pushes the net bag 3 into the mouth and the biting range extends to an area near the fixing hoop 2, the infant's direct biting area on the fixing hoop 2 becomes relatively small under the shielding of the enclosing wall 12. More biting force is applied directly to the enclosing wall 12 of the cover 1. That is, the effective biting area on the fixing hoop 2 is minimized to prevent the infant from pulling off the fixing hoop 2 from the food chewing device during use, ensuring the connection stability between the net bag 3 and the cover 1, and avoiding a scenario where the infant might swallow the net bag 3 mistakenly due to the net bag 3 falling off.

In this embodiment, the first fixing ring 32 is provided with a first clamping groove 321. A peripheral portion of the blocking block 11 is provided with a second clamping groove 112. Mounting holes 21 are formed on and extended through the fixing hoop 2. An open end of the net bag 3 and one end of the blocking block 11 provided with the blocking side face 113 are inserted in the mounting hole 21 from two ends of the mounting hole 21, respectively. A second fixing ring 22 extends from one end of the fixing hoop 2 close to the net bag 3 and facing the center of the mounting hole 21. The second fixing ring 22 abuts the first fixing ring 32. A first clamping block 221 connected to the first clamping groove 321 is disposed on the second fixing ring 22. A second clamping block 25 connected to the second clamping groove 112 is disposed on a hole wall of the mounting hole 21. That is, the fixing hoop 2 is clamped to the blocking block 11 and the first fixing ring 32 separately.

Further, the outer side surface of the fixing hoop 2 includes an outer peripheral side face 23 and a first transition arc face 24 connected to the outer peripheral side face 23. The first transition arc face 24 is a convex arc face. The outer peripheral side face 23 is connected to an end face of one end of the second fixing ring 22 facing away from the cover 1 through the first transition arc face 24. The enclosing wall 12 shields at least the outer peripheral side face 23. In this embodiment, in a use state, the second fixing ring 22 is disposed at one end of the fixing hoop 2 close to the infant. The first transition arc face 24 is disposed between the outer peripheral side face 23 of the fixing hoop 2 and the second fixing ring 22 so that the outer surface of the fixing hoop 2 is smooth, avoiding the fixing hoop 2 from scratching the skin of the infant. It is to be understood that, in a use state, the outer peripheral side face 23 is perpendicular to the face of the infant. The enclosing wall 12 shields at least the outer peripheral side face 23, avoiding the infant from directly biting on the outer peripheral side face 23 of the fixing hoop 2, thereby reducing the effective biting area on the fixing hoop 2, and avoiding the fixing hoop 2 from falling off. Due to the particularity of the arc-shaped structure of the first transition arc face 24, a “slip” phenomenon occurs when the infant bites the first transition arc face 24, avoiding the fixing hoop 2 from being pulled off.

Optionally, the enclosing wall 12 shields a portion of the first transition arc face 24. The enclosing wall 12 shields a portion of the first transition arc face 24, ensuring that the enclosing wall 12 completely shields the outer peripheral side face 23 of the fixing hoop 2, thereby providing a certain precision error for the machining of the enclosing wall 12, and reducing the manufacturing difficulty and the manufacturing cost.

Specifically, the blocking side face 113 is provided with a fitting portion 111. The fitting portion 111 is inserted in the open end. An end face of the enclosing wall 12 protrudes from the blocking side face 113. The fitting portion 111 can increase the contact area between the net bag 3 and the cover 1. The end face of the enclosing wall 12 protrudes from the blocking side face 113 so that the infant excessively pushes the net bag 3 into the mouth and the biting range extends to an area near the enclosing wall 12, the enclosing wall 12 abuts the fixing hoop 2 under the action of a biting force, making the fixing hoop 2 and the fitting portion 111 together clamp the net bag 3, and increasing the friction force between the net bag 3, the cover 1, and the fixing hoop 2, thereby preventing the fixing hoop 2 and the net bag 3 from being pulled off. In this embodiment, the fitting portion 111 has an interference fit with the net bag 3 so that the connection stability between the cover 1 and the net bag 3 can be improved. In this embodiment, the diameter of the blocking block 11 is 35 mm. The diameter of the fitting portion 111 is 20 mm. The blocking block 11 and the fitting portion 111 are coaxially disposed. The height of the fitting portion 111 is 7 mm. The overall height of the fixing hoop 2 is 16.50 mm. The height of the outer peripheral side face 23 of the fixing hoop 2 is 12 mm.

Further, the thickness of the enclosing wall 12 gradually reduces in the direction from the cover 1 to the net bag 3. The thickness of the surrounding wall 12 gradually reduces, improving the appearance of the infant food chewing device, and making the infant food chewing device full of aesthetic feeling.

Further, one side surface of the enclosing wall 12 facing away from the fixing hoop 2 is an inclined surface 122. One side surface of the enclosing wall 12 facing away from the fixing hoop 2 is the inclined surface 122 so that the enclosing wall 12 can be smoothly connected to the first transition arc face 24 of the fixing hoop 2, thereby improving the infant use experience. Of course, one side surface of the enclosing wall 12 facing away from the fixing hoop 2 is not limited to the inclined surface 122, and may be a convex arc face.

Optionally, an included angle θ between the inclined surface 122 and one side surface of the enclosing wall 12 facing the blocking block 11 is θ. 15°≤θ≤25°. The range of θ is between 15° and 25°, ensuring the thickness of the connection position between the enclosing wall 12 and the blocking block 11, thereby ensuring the connection strength between the enclosing wall 12 and the blocking block 11.

Optionally, θ=20°. In this way, the appearance and the thickness of the enclosing wall 12 can be taken into account as much as possible to ensure the connection stability between the enclosing wall 12 and the blocking block 11. In other optional embodiments, θ may also be 15°, 16°, 17°, 18°, 19°, 20°, 21°, 22°, 23°, 24°, and 25°.

Optionally, the end face of the enclosing wall 12 is a second transition arc face 121. The second transition arc face 121 is a convex arc face. The end face of the enclosing wall 12 is the convex second transition arc face 121. The second transition arc face 121 can smoothly connect the inclined surface 122 of the enclosing wall 12 to the inner side of the enclosing wall 12 (i.e. a side surface of the enclosing wall 12 facing the blocking block 11), avoiding the angular structure of the enclosing wall 12, thereby avoiding the enclosing wall 12 from scratching the skin of the infant during the use. In this embodiment, the enclosing wall 12 and the blocking block 11 are integrally formed so that the height of the enclosing wall 12 is 11 mm. The height is set so that the enclosing wall 12 can cover the first transition arc face 24 of the fixing hoop 2 after the cover 1 and the fixing hoop 2 are combined, and the biting range (area) of the fixing hoop 2 is shielded.

Referring to FIG. 9, optionally, the infant food chewing device includes a dust cover 4. A first buckle member 123 is disposed on one side surface of the enclosing wall 12 facing away from the fixing hoop 2. A second buckle member 41 is disposed on the inner wall of the dust cover 4. The first buckle member 123 and the second buckle member 41 are buckled. The net bag 3 and the fixing hoop 2 are located inside the dust cover 4. In this embodiment, the first buckle member 123 is a one ring-shaped groove structure provided on the outer surface of the enclosing wall 12. The second buckle member 41 is a one ring-shaped convex provided on the inner surface of the dust cover 4. The second buckle member 41 is inserted in the first buckle member 123 to achieve the cover of the dust cover 4 and the cover 1. The dust cover 4 can cover the cover body 1 in a non-use state, avoiding the net bag 3 from being exposed, thereby avoiding contaminating the net bag 3. In this embodiment, the dust cover 4 is U-shaped as a whole, 58 mm high and hollow inside. The effective depth of the dust cover 4 is 55 mm. The dust cover 4 can be used for placing food and provided with scale lines. An upper end portion of the dust cover 4 is in the shape whose the outer edge tapers with the maximum diameter of 50 mm and the minimum diameter of 40 mm. The shape is viewed as a bowl, and the bowl-shaped portion is 16 mm in height. The part with the maximum diameter is set as an opening. The first buckle member 123 has a groove width of 1 mm and a depth of 1 mm. The size of the second buckle member 41 corresponds to the size of the first buckle member 123.

Further, in this embodiment, the first clamping groove 321 is an annular clamping groove. The first clamping block 221 is an annular projection. The first clamping block 221 is inserted in the first clamping groove 321 to be clamped. The second clamping groove 112 is an annular clamping groove. The second clamping block 25 is an annular projection. The second clamping block 25 is inserted in the second clamping groove 112 to be clamped. The groove direction of the second clamping groove 112 and the groove direction of the first clamping groove 321 are disposed at an included angle. Optionally, the groove direction of the first clamping groove 321 is perpendicular to the groove direction of the second clamping groove 112. One clamping groove is provided on the net bag 3. One clamping groove is provided on the net bag 3. The groove directions of the two clamping grooves are disposed at an included angle. Corresponding to each clamping groove, the fixing hoop 2 is provided with one annular clamping block, forming a double clamping structure. The double clamping structure forms a mutual clamping force, increasing the connection strength of the net bag 3, the cover 1 and the fixing hoop 2 after assembly, and effectively preventing the net bag 3 from being separated from the fixing hoop 2. Moreover, the double clamping structure can also form a double seal, effectively increasing the sealing effect between the cover 1 and the net bag 3, preventing the food juice in the net bag 3 from flowing out from the joint position of the net bag 3 and the cover 1. In this embodiment, the second clamping groove 112 has a groove width of 6 mm and a depth of 2 mm. The size of the second clamping block 25 corresponds to the size of the second clamping groove 112. The first fixing ring 32 has a diameter of 33 mm and a thickness of 2 mm. The first clamping groove 321 has a groove width of 3 mm and a depth of 1 mm. The size of the first clamping block 221 corresponds to the size of the first clamping groove 321. The open end of the bag body 31 has an aperture of 22 mm and is rounded.

In this embodiment, the net bag 3, the cover 1 and the fixing hoop 2 are all made of silica gel. This design enables the whole infant food chewing device to have a more comfortable hand feel and taste, avoiding contact of hard plastic or metal materials with the mouth and hands of the infant, and reducing the resistance of the infant during use. The diameter of each through hole 312 on the net bag 3 is 2 mm. The food juice flows out from the net bag 3 to filter and isolate food residues. The capacity of the net bag 3 may be set in large, medium and small sizes and designed according to different loads.

Optionally, the cover body is provided with a handle 13 on one side facing away from the net bag 3. The handle 13 is provided so that it is convenient for the infant to hold the infant food chewing device while feeding.

Optionally, the handle 13 is an elliptical ring, and this design can enhance the comfort of holding. More optionally, the outer wall of the handle 13 is provided with multiple protruding massage points that can massage the gum of the infant when the infant is biting, relieving the pain caused by the tooth eruption. More optionally, the massage points are several semicircular protruding points protruding on the surface of the handle 13.

In this embodiment, the handle 13 and the cover 1 are integrally formed using the silica gel. The integrally forming can reduce the manufacturing difficulty, avoiding the assembly of the handle 13 and the cover 1, and reducing the assembly cost. In addition, the handle 13 made of the silica gel can also make the infant more comfortable during holding.

Moreover, the handle 13 is provided with a first protrusion 131 whose surface is provided with bristles 1311. The bristles 1311 can clean the mouth cavity of the infant and can massage the gum when the infant is biting, thereby relieving the pain caused by the tooth eruption. Specifically, the bristles 1311 are several cylindrical structures protruding on the surface of the first projection 131.

The handle 13 is further provided with a second protrusion 132 whose surface is provided with a massage protrusion 1321. The massage protrusion 1321 is multiple corrugated convex strips protruding on the surface of the second protrusion 132. The corrugated convex strips can also massage the gum when the infant is biting, relieving the pain caused by the tooth eruption.

Specifically, the first protrusion 131 and the second protrusion 132 are both disposed on the same side of the elliptical handle 13, i.e. on one side of the handle 13 facing away from the cover 1. The first protrusion 131 and the second protrusion 132 are disposed symmetrically along the center of the handle 13. The first protrusion 131 and the second protrusion 132 are in the same flat shape. Corner positions are in the manner of arc chamfers.

In the description of the present application, it is to be noted that orientations or position relations indicated by terms such as “above”, “below”, “left” and “right” are based on the drawings. These orientations or position relations are intended only to facilitate the description and simplify the operation and not to indicate or imply that a device or element referred to must have such particular orientations or must be configured or operated in such particular orientations. Thus, these orientations or position relations are not to be construed as limiting the present application. In addition, the terms “first” and “second” are used only to distinguish between descriptions and have no special meaning.

It is to be noted that in the description of the specification, the description of reference terms such as “an embodiment” and “example” is intended to mean that specific features, structures, materials or characteristics described in conjunction with such embodiments or examples are included in at least one embodiment or example of the present application. In the specification, the illustrative description of the preceding terms does not necessarily refer to the same embodiment or example.

Moreover, it is to be understood that although this specification is described in terms of the embodiments, not each embodiment includes only one independent technical solution. Such description mode of the specification is merely for the sake of clarity, and those skilled in the art should regard the specification as a whole. The solutions in the embodiments may also be appropriately combined to form other embodiments which will be understood by those skilled in the art.

The principle of the present application is described above in conjunction with specific embodiments. The description is merely used for explaining the present application and is not intended to be explained in any means as limitations to the present application. Based on the explanations herein, other embodiments of the present application obtained by those skilled in the art are within the scope of the present application on the premise that no creative work is done.

What is claimed is:

1. An infant food chewing device, comprising: a net bag, a cover, and a fixing hoop, wherein the net bag comprises a bag body having a receiving cavity, a cavity wall of the receiving cavity is provided with a plurality of through holes for food to pass through, a first fixing ring extends from one side of an open end of the bag body facing away from a center of the open end, the cover comprises a cover body having a mounting side surface, an enclosing wall and a blocking block are disposed on the mounting side surface, the blocking block is located in an annular area of the enclosing wall, the blocking block and the enclosing wall are spaced apart, the blocking block has a blocking side face abutting an end face of the open end and blocking the open end, the fixing hoop is sleeved on an outer periphery of the blocking block and the first fixing ring, the fixing hoop is detachably connected to both the blocking block and the first fixing ring, and the enclosing wall at least partially shields an outer side surface of the fixing hoop.

2. The infant food chewing device of claim 1, wherein the outer side surface of the fixing hoop comprises an outer peripheral side face and a first transition arc face connected to the outer peripheral side face, the first transition arc face is a convex arc face, the outer peripheral side face and the first transition arc face are disposed in an axial direction of the fixing hoop, the first transition arc face is disposed on one side of the outer peripheral side face close to the net bag, and the enclosing wall shields at least the outer peripheral side face.

3. The infant food chewing device of claim 2, wherein the enclosing wall shields a portion of the first transition arc face.

4. The infant food chewing device of claim 1, wherein the blocking side face is provided with a fitting portion, the fitting portion is inserted in the open end, and an end face of the enclosing wall protrudes from the blocking side face.

5. The infant food chewing device of claim 1, wherein a thickness of the enclosing wall gradually reduces in a direction from the cover to the net bag.

6. The infant food chewing device of claim 2, wherein a thickness of the enclosing wall gradually reduces in a direction from the cover to the net bag.

7. The infant food chewing device of claim 3, wherein a thickness of the enclosing wall gradually reduces in a direction from the cover to the net bag.

8. The infant food chewing device of claim 5, wherein one side surface of the enclosing wall facing away from the fixing hoop is an inclined surface.

9. The infant food chewing device of claim 8, wherein an included angle between the inclined surface and one side surface of the enclosing wall facing the blocking block is θ, wherein 15°≤θ≤25°.

10. The infant food chewing device of claim 9, wherein θ=20°.

11. The infant food chewing device of claim 1, wherein an end face of the enclosing wall is a second transition arc face, and the second transition arc face is a convex arc face.

12. The infant food chewing device of claim 2, wherein an end face of the enclosing wall is a second transition arc face, and the second transition arc face is a convex arc face.

13. The infant food chewing device of claim 3, wherein an end face of the enclosing wall is a second transition arc face, and the second transition arc face is a convex arc face.

14. The infant food chewing device of claim 1, further comprising a dust cover, wherein a first buckle member is disposed on one side surface of the enclosing wall facing away from the blocking block, a second buckle member is disposed on an inner wall of the dust cover, the first buckle member and the second buckle member are buckled, and the net bag and the fixing hoop are located inside the dust cover.

15. The infant food chewing device of claim 2, further comprising a dust cover, wherein a first buckle member is disposed on one side surface of the enclosing wall facing away from the blocking block, a second buckle member is disposed on an inner wall of the dust cover, the first buckle member and the second buckle member are buckled, and the net bag and the fixing hoop are located inside the dust cover.

16. The infant food chewing device of claim 3, further comprising a dust cover, wherein a first buckle member is disposed on one side surface of the enclosing wall facing away from the blocking block, a second buckle member is disposed on an inner wall of the dust cover, the first buckle member and the second buckle member are buckled, and the net bag and the fixing hoop are located inside the dust cover.
